(19) United States
(12) Patent Application Publication
(10) Pub. No.: US 2012/0312642 A1
(43) Pub. Date: Dec. 13, 2012

(54) Friction pad spreader, assembly including same and method of mounting thereof

(76) Inventor: Robert Bosco, JR., Wolcott, CT (US)

(21) Appl. No.: 13/134,640

(22) Filed: Jun. 13, 2011

(51) Int. Cl. F16D 55/22; B23P 11/00

(52) U.S. Cl. 188/72.3; 29/428

(57) ABSTRACT

A friction pad drag reduction assembly for reducing drag between a rotor and friction pads, wherein the assembly comprises one or more pad spreaders that upon a removal of the braking force, urge the friction pads away from the rotor. The invention is also directed to the pad spreaders themselves and to methods of assembling friction pad drag reduction assemblies that includes one or more of the pad spreaders.

### BACKGROUND OF THE INVENTION

This invention relates generally to devices and assemblies for reducing the drag of a friction pad on a rotor, and in particular, to improved friction pad spreading devices, assemblies including the same and methods of mounting the pad spreading devices, all of which lends themselves to a more universally usable and advantageous construction, implementation and installation.

Friction pad spreading devices are known to reduce drag of a friction pad on the rotor of a disc brake assembly. For example, the reduction of drag on the rotor (i.e. the reduction of unwanted friction between the rotor and the friction pad after a braking operation is completed) can provide for increased gas mileage and longer life of the friction pads, two very desirable objectives, especially when brake repairs and/or gas prices are high. Ideally, when the brake pedal is released, the friction pads should spread apart from one another to prevent unwanted and/or undesirable frictional engagement with the rotor. To accomplish this, it is known to provide the disc brake assembly with one or more springs for moving the brake shoes apart from one another when the brake pedal is released.

One example of such a retractor clip is described in U.S. Pat. No. 5,549,181. It is noted that this patent appears to describe yet additional patents that may describe disc brake assemblies that include retraction spring structures.

However, it is believed that deficiencies still exist in the state of the art. For example, the aforementioned '181 patent describes the need for a particular structure that requires carefully aligned apertures and fasteners, which makes for a less than interchangeable and universally adaptable and useable arrangement. That is, the '181 patent, as just one example, requires a specifically designed retractor clip for the particular brake assembly configuration illustrated.

In view thereof, it has been discovered that still further developments in the art are desirable. For example, it would be quite advantageous to provide a pad spreader that can be more universally used with various constructions of disc or other types of brake assemblies. Such a pad spreading device would significantly reduce the cost of wear on the friction pads, increase gas mileage and provide manufacturers and after market third parties with an improved way to achieve the foregoing for their customers.

It has thus been discovered that improved pad spreading devices and assemblies formed thereby are achievable and provided by the present invention, and it is further believed that the present invention overcomes the perceived deficiencies in the prior art as well as provides the objectives and advantages set forth above and below.

### OBJECTS AND SUMMARY AND OBJECTIVES OF THE INVENTION

Therefore, it is an object and advantage of the present invention to provide an improved friction pad spreading device that overcomes the perceived deficiencies in the prior art.

It is a further object and advantage of the present invention to provide an improved methodology of installing a friction pad spreading device into a braking assembly.

It is a further object and advantage of the present invention to provide an improved friction pad spreading device that operates effectively over the life of the friction pad, thereby providing sufficient compression and restoring forces regardless of the wear upon the friction pad.

It is another object and advantage of the present invention to provide an improved friction pad spreading device that can provide for increased gas mileage and prolonged life of the braking pad, just to name but a few advantageous results.

Further objects and advantages of this invention will become more apparent from a consideration of the drawings and ensuing description.

The invention accordingly comprises the features of construction, combination of elements, arrangement of parts and sequence of steps that will be exemplified in the disclosure hereinafter set forth, and the scope of the invention will be indicated in the claims.

To overcome the perceived deficiencies in the prior art and to achieve the objects and advantages above and below, the present invention in a first preferred embodiment, is generally speaking, directed to a friction pad drag reduction assembly for reducing drag between a rotor and at least a first friction pad of a first braking subassembly that itself also comprises a first backing plate, wherein the first backing plate comprises a first end and a second end, wherein the assembly comprises a second braking subassembly comprising a second friction pad in facing alignment with the rotor, and a second backing plate to which the second friction pad is coupled, the second backing plate having a first end and a second end; a caliper bracket that slidably supports, on a first side thereof, the first end of the first backing plate and the first end of the second backing plate, and, on a second side thereof, the second end of the first backing plate and the second end of the second backing plate; a first pad spreader, comprising a loop section and at least a first end and a second end, wherein the first end engages the first end of the first backing plate and the second end engages the first end of the second backing plate; a second pad spreader, comprising a loop section and at least a first end and a second end, wherein the first end engages the second end of the first backing plate and the second end engages the second end of the second backing plate; wherein the first and second spreaders are secured to the assembly by (i) only the first and second ends of each pad spreader or (ii) the first and second ends of each pad spreader along with the respective loop sections of both the first pad spreader and the second pad spreader being snap fit onto the caliper bracket; wherein upon an application of a braking force, the assembly urges the first friction pad of the first braking subassembly and the second friction pad of the second braking subassembly towards the rotor; and upon a removal of the braking force, the first and second pad spreaders urge the first friction pad of the first braking subassembly and the second friction pad of the second braking subassembly away from the rotor.

In a specific embodiment, the caliper bracket includes a first guide rail and a second guide rail, wherein the first end of the first backing plate is slidable along the first guide rail and the second end of the first backing plate is slidable along the second guide rail, and the first end of the second backing plate is slidable along the first guide rail and the second end of the second backing plate is slidable along the second guide rail, the first end of the first pad spreader is in pressing engagement against the first end of the first backing plate and the second end of the first pad spreader is in pressing engagement against the first end of the second backing plate; the first end of the second pad spreader is in pressing engagement against the second end of the first backing plate and the second end of the second pad spreader is in pressing engagement against the second end of the second backing plate; and the loop sections of both the first and second pad spreaders are snap fit onto the caliper bracket.

In another specific embodiment, the caliper bracket includes a first guide rail and a second guide rail, wherein the first end of the first backing plate is slidable along the first guide rail and the second end of the first backing plate is slidable along the second guide rail, and the first end of the second backing plate is slidable along the first guide rail and the second end of the second backing plate is slidable along the second guide rail, the first end of the first pad spreader is in pressing engagement against the first end of the first backing plate and the second end of the first pad spreader is in pressing engagement against the first end of the second backing plate; the first end of the second pad spreader is in pressing engagement against the second end of the first backing plate and the second end of the second pad spreader is in pressing engagement against the second end of the second backing plate; and the loop sections of both the first and second pad spreaders are not snap fit to the caliper bracket.

In yet another specific embodiment, the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot, the first end of the first pad spreader is in pressing engagement against the first end of the first backing plate and the second end of the first pad spreader is in pressing engagement against the first end of the second backing plate; the first end of the second pad spreader is in pressing engagement against the second end of the first backing plate and the second end of the second pad spreader is in pressing engagement against the second end of the second backing plate; and the loop sections of both the first and second pad spreaders are snap fit onto the caliper bracket.

In yet another specific embodiment, the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot, the first end of the first pad spreader is in pressing engagement against the first end of the first backing plate and the second end of the first pad spreader is in pressing engagement against the first end of the second backing plate; the first end of the second pad spreader is in pressing engagement against the second end of the first backing plate and the second end of the second pad spreader is in pressing engagement against the second end of the second backing plate; and the loop sections of both the first and second pad spreaders are not snap fit to the caliper bracket.

And yet in another specific embodiment, the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot, the first end of the first pad spreader wraps around the first end of the first backing plate and the second end of the first pad spreader wraps around the first end of the second backing plate; the first end of the second pad spreader wraps around the second end of the first backing plate and the second end of the second pad spreader wraps around the second end of the second backing plate; and the loop sections of both the first and second pad spreaders are not snap fit to the caliper bracket.

In other preferred embodiments, the invention is directed to pad spreaders for use in such friction pad drag reduction assemblies.

In yet other preferred embodiments, the present invention is directed to methods of assembling such friction pad drag reduction assemblies.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 illustrates a pad spreading device constructed in accordance with a preferred embodiment of the present invention;

FIGS. 2A, 2B and 2C (also collectively referred to herein as “FIG. 2”) are perspective views of a conventional vehicle brake assembly, such as a disc-brake assembly, in various states of assembly, generally showing the friction pad spreading device constructed in accordance with the preferred embodiment of FIG. 1;

FIG. 3 illustrates a pad spreading device constructed in accordance with another preferred embodiment of the present invention;

FIGS. 4A, 4B and 4C (also collectively referred to herein as “FIG. 4”) are perspective views of another convention vehicle brake assembly in various states of assembly, and which generally show the assembling and mounting of the friction pad spreading device constructed in accordance with the preferred embodiment of FIG. 3;

FIG. 5 illustrates a pad spreading device constructed in accordance with another preferred embodiment of the present invention;

FIGS. 6A, 6B, 6C, 6D and 6E (also collectively referred to herein as “FIG. 6”) are perspective views of another convention vehicle brake assembly in various states of assembly, and which generally show the assembling and mounting of the friction pad spreading device constructed in accordance with the preferred embodiment of FIG. 5;

FIG. 7 illustrates a pad spreading device constructed in accordance with another preferred embodiment of the present invention;

FIGS. 8A, 8B, 8C, 8D and 8E (also collectively referred to herein as “FIG. 8”) are perspective views of another conventional vehicle brake assembly in various states of assembly, and which generally show the assembling and mounting of the friction pad spreading device constructed in accordance with the preferred embodiment of FIG. 7;

FIG. 9 illustrates a pad spreading device constructed in accordance with another preferred embodiment of the present invention;

FIGS. 10A, 10B and 10C (also collectively referred to herein as “FIG. 10”) are perspective views of another conventional vehicle brake assembly in various states of assembly, and which generally show the assembling and mounting of the friction pad spreading device constructed in accordance with the preferred embodiment of FIG. 9;

FIG. 11 illustrates a pad spreading device constructed in accordance with another preferred embodiment of the present invention;

FIGS. 12A, 12B, 12C and 12D (also collectively referred to herein as “FIG. 12”) are perspective views of another conventional vehicle brake assembly in various states of assembly, and which generally show the assembling and mounting of the friction pad spreading device constructed in accordance with the preferred embodiment of FIG. 11;

FIG. 13 illustrates a pad spreading device constructed in accordance with another preferred embodiment of the present invention; and

FIGS. 14A, 14B and 14C (also collectively referred to herein as “FIG. 14”) are perspective views of another conventional vehicle brake assembly in various states of assembly, and which generally show the assembling and mounting of the friction pad spreading device constructed in accordance with the preferred embodiment of FIG. 13.

Like numbers to identify like parts and features will be used among the various figures, but not all features will be specifically identified in each illustration.

### DETAILED DESCRIPTION OF THE PREFERRED EMBODIMENTS

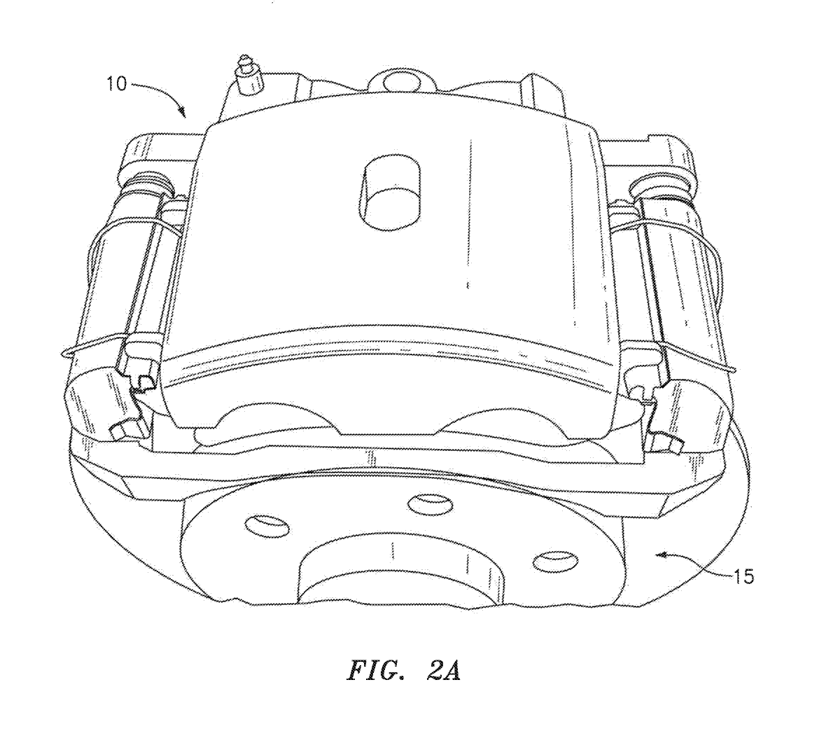

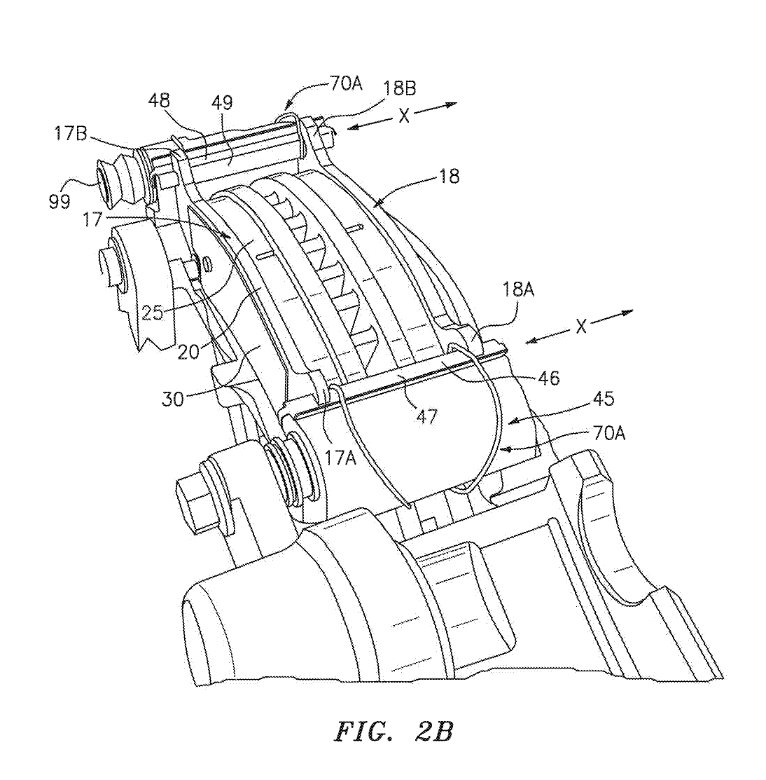

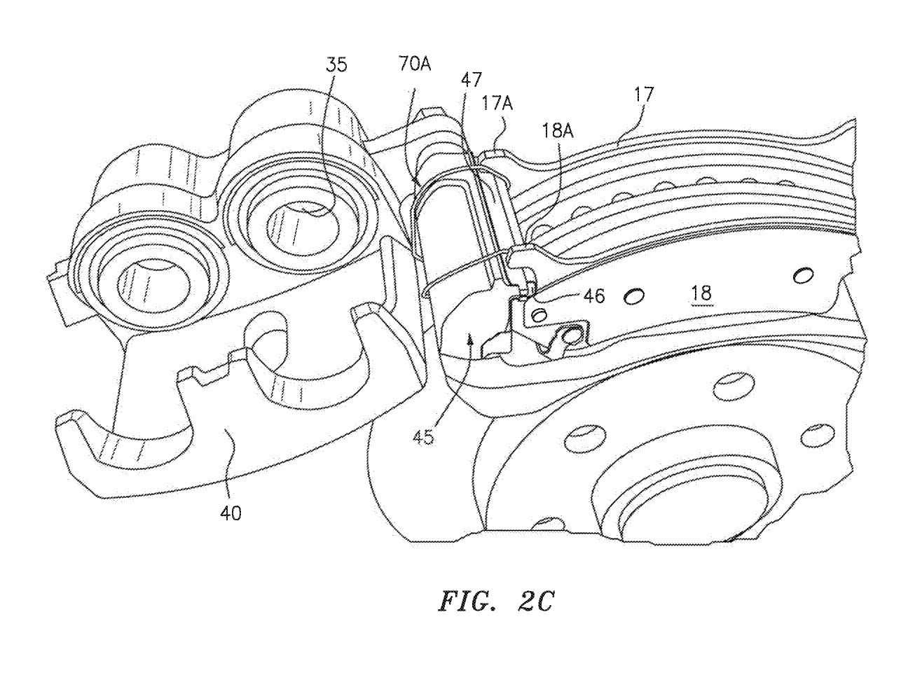

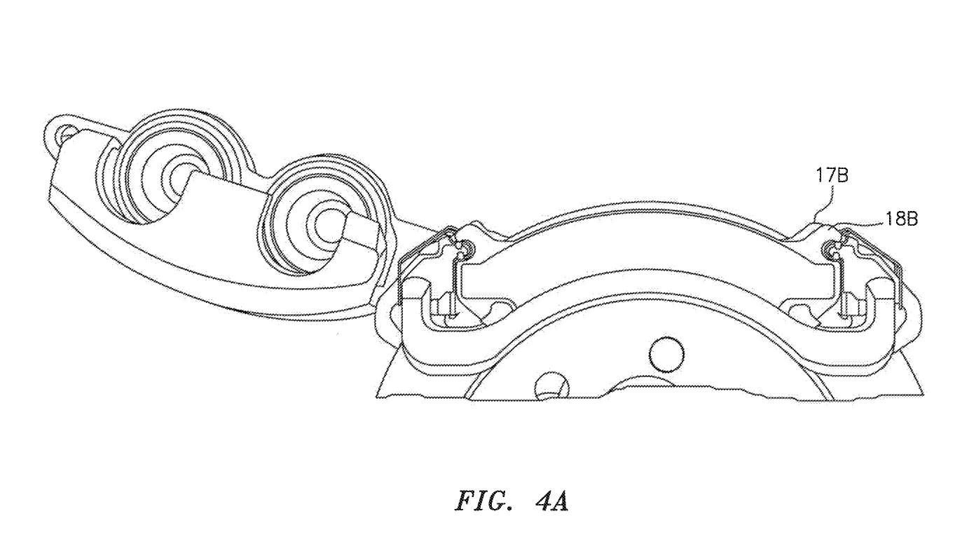

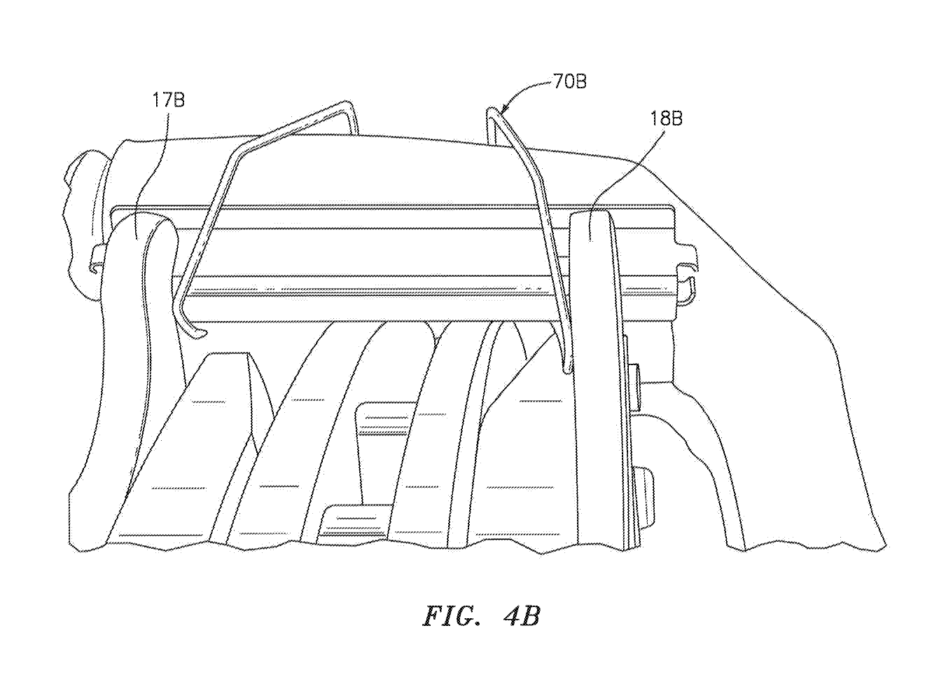

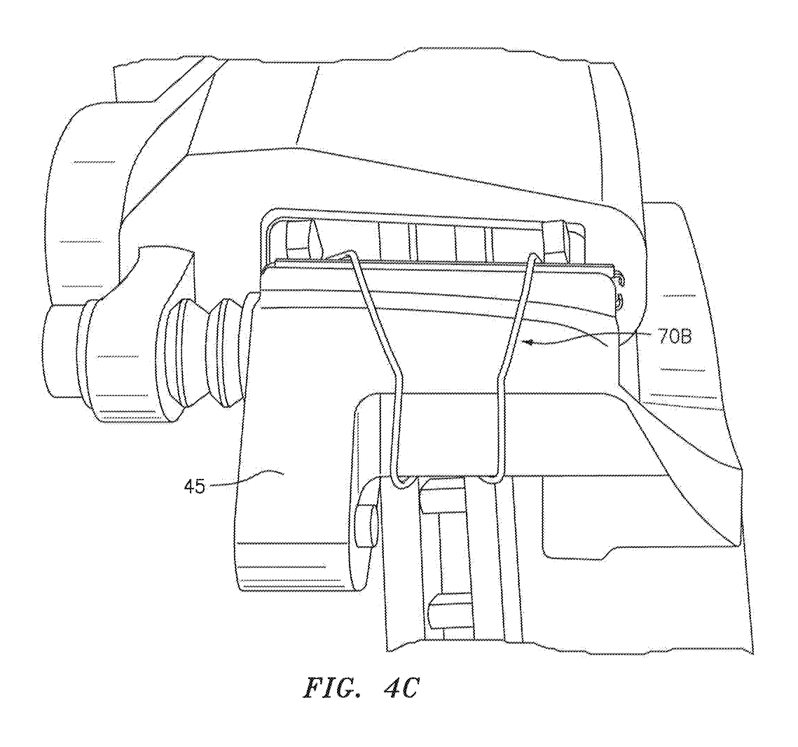

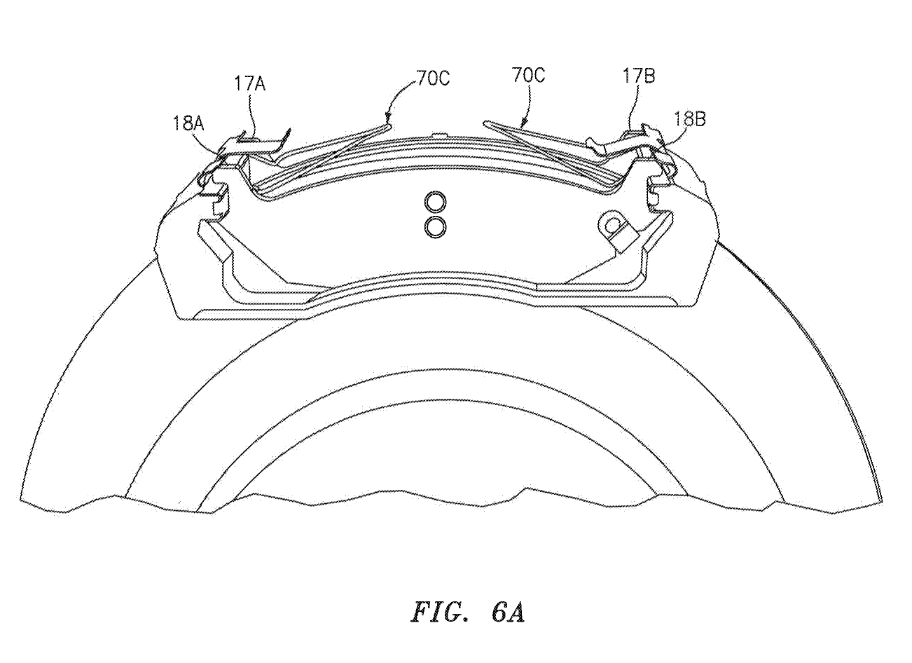

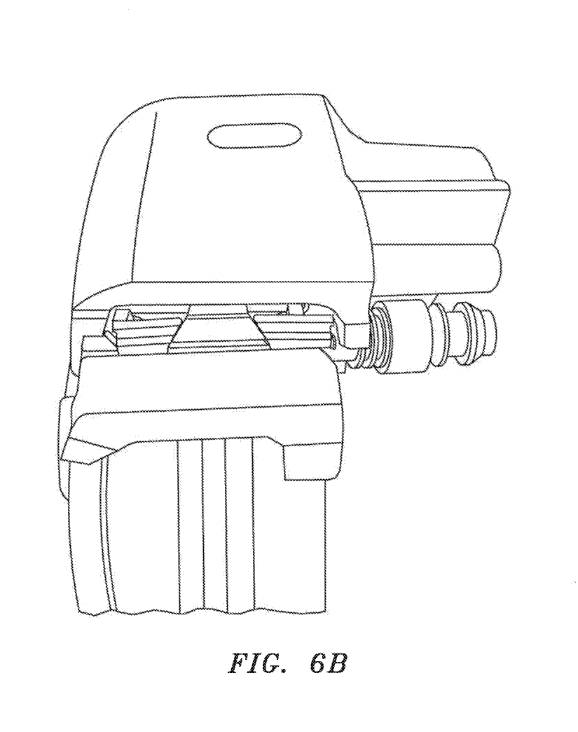

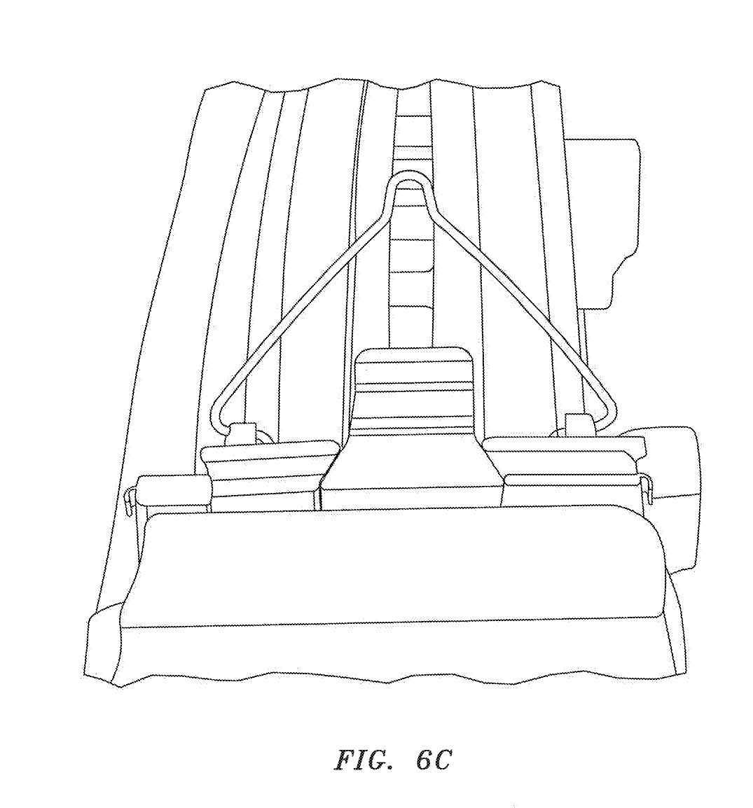

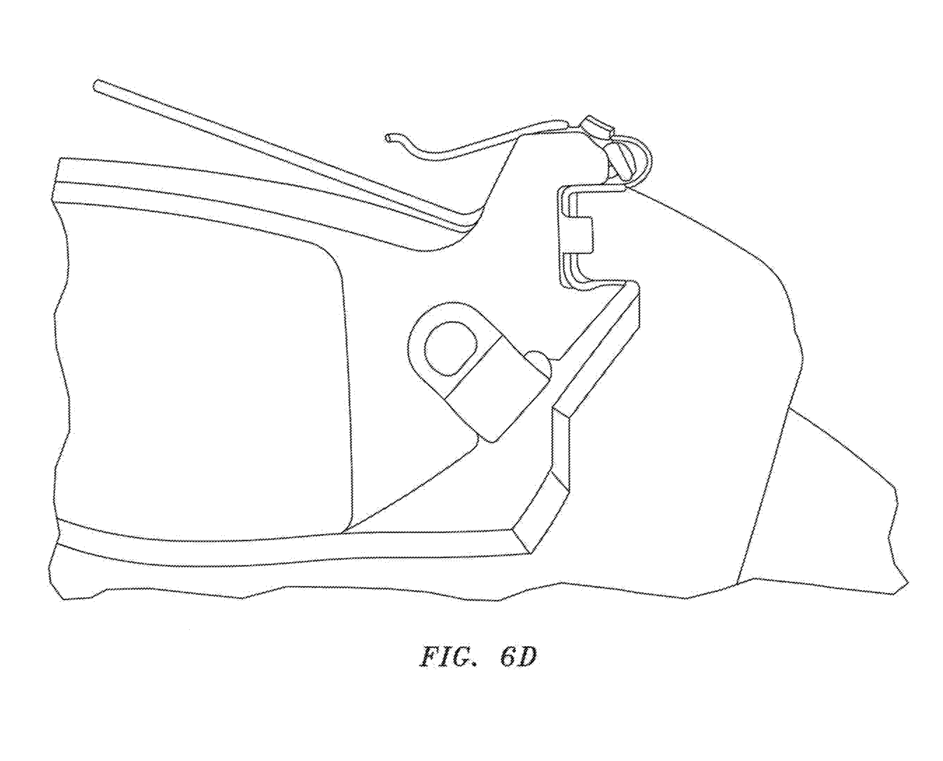

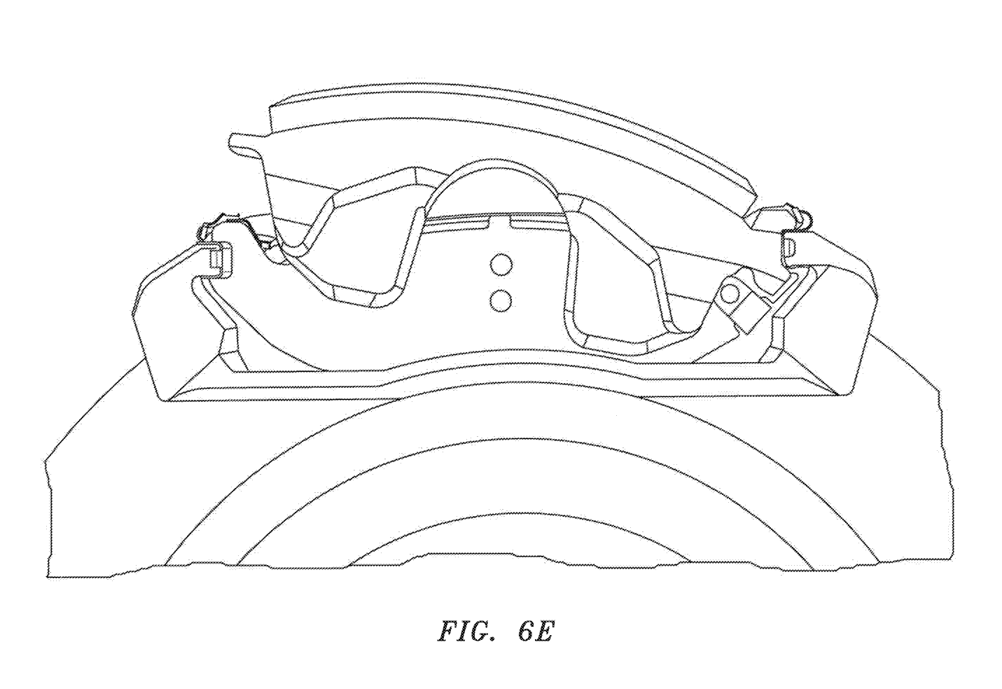

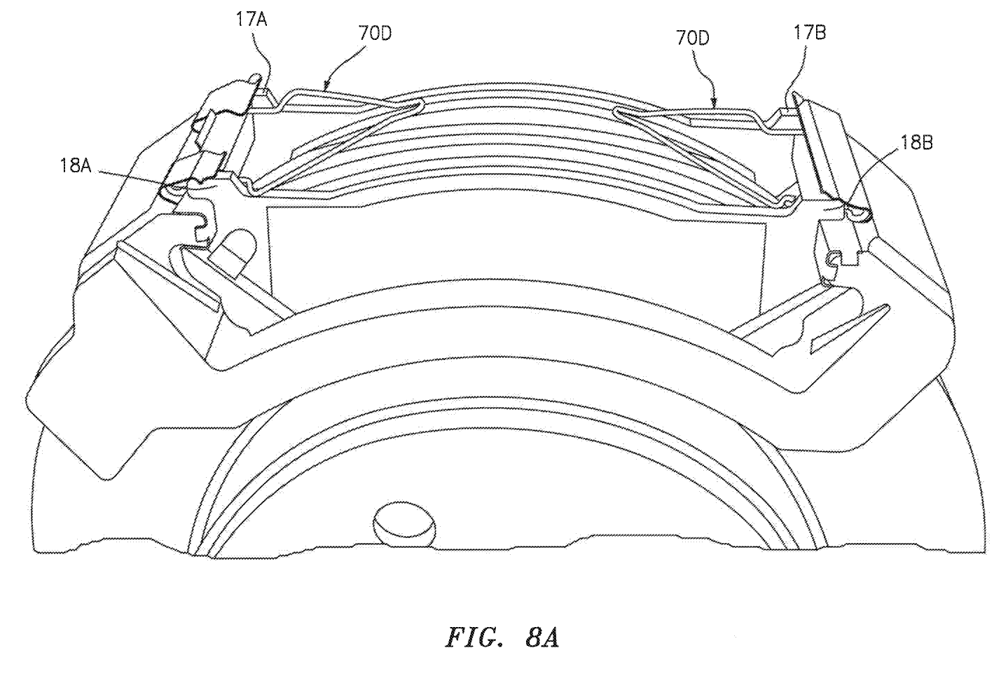

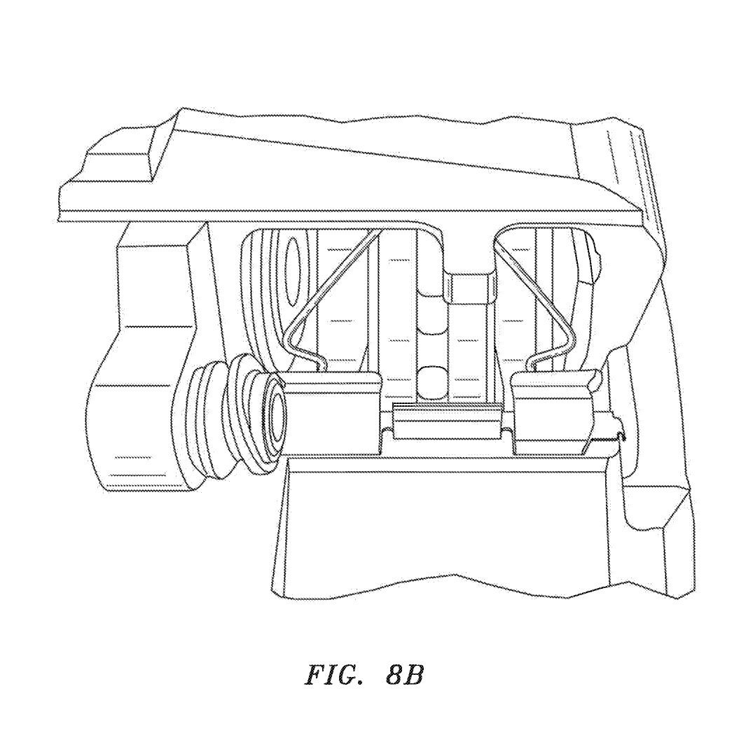

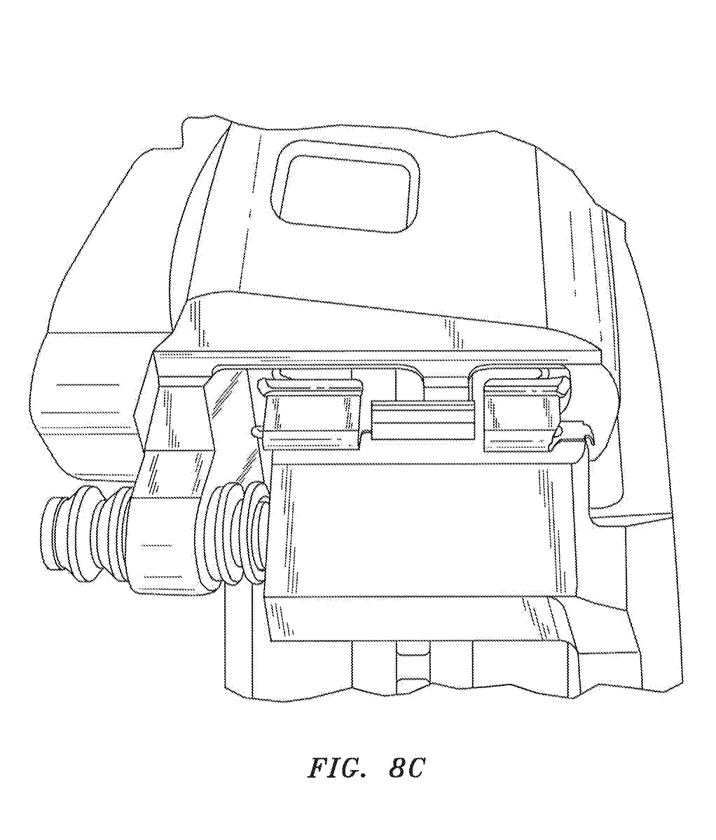

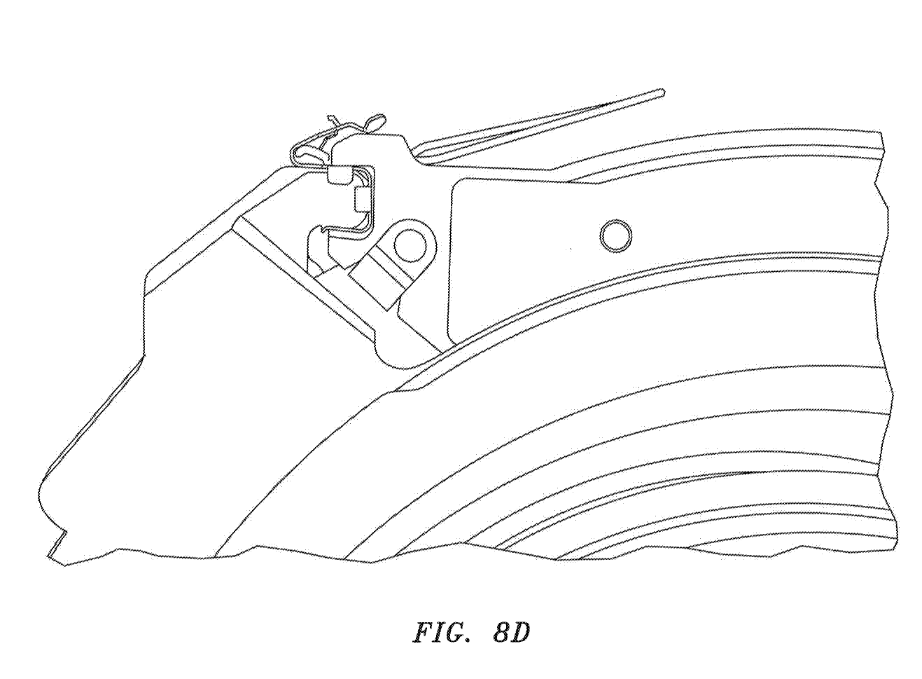

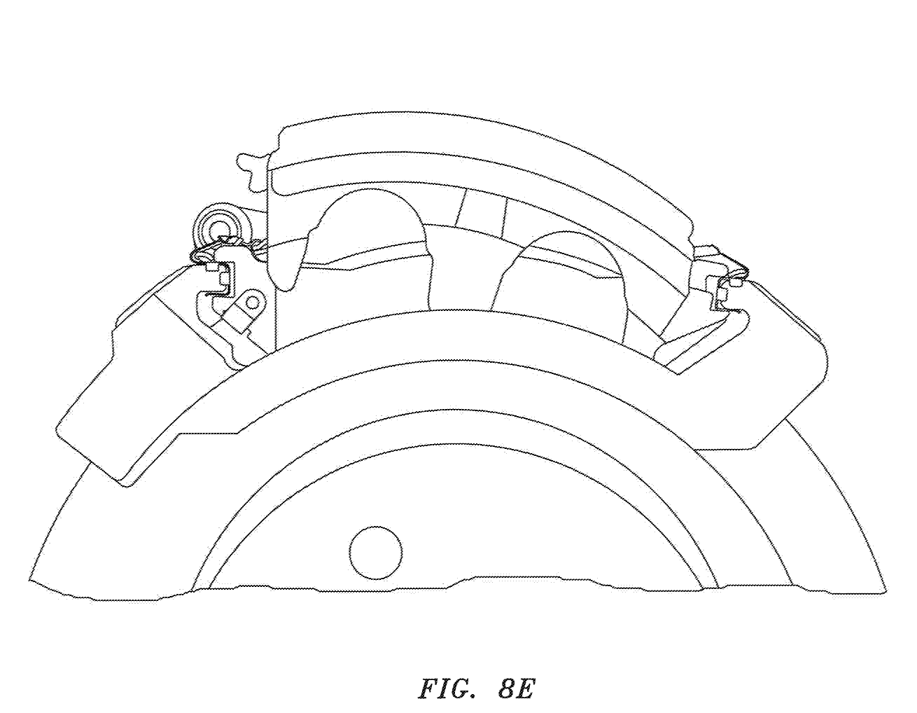

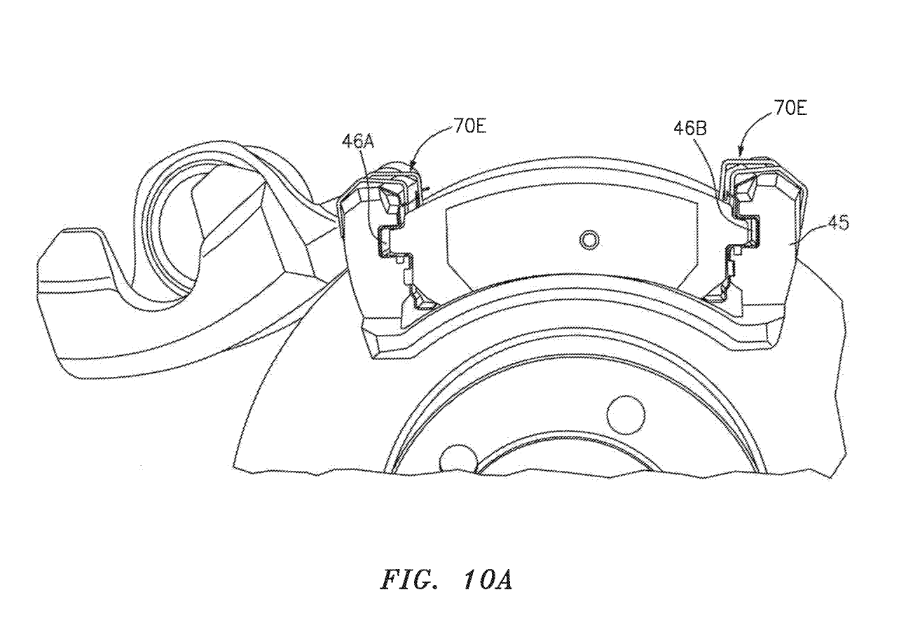

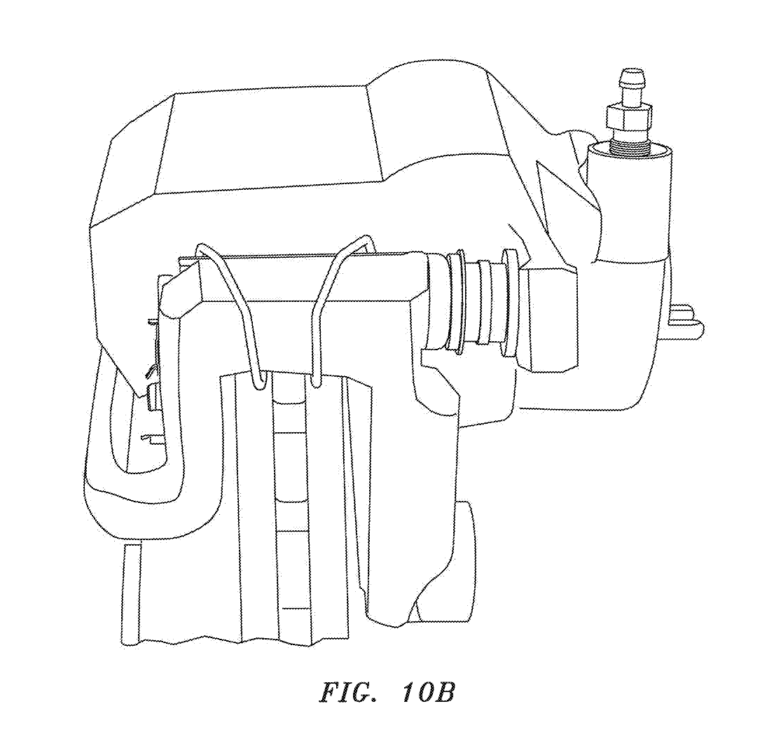

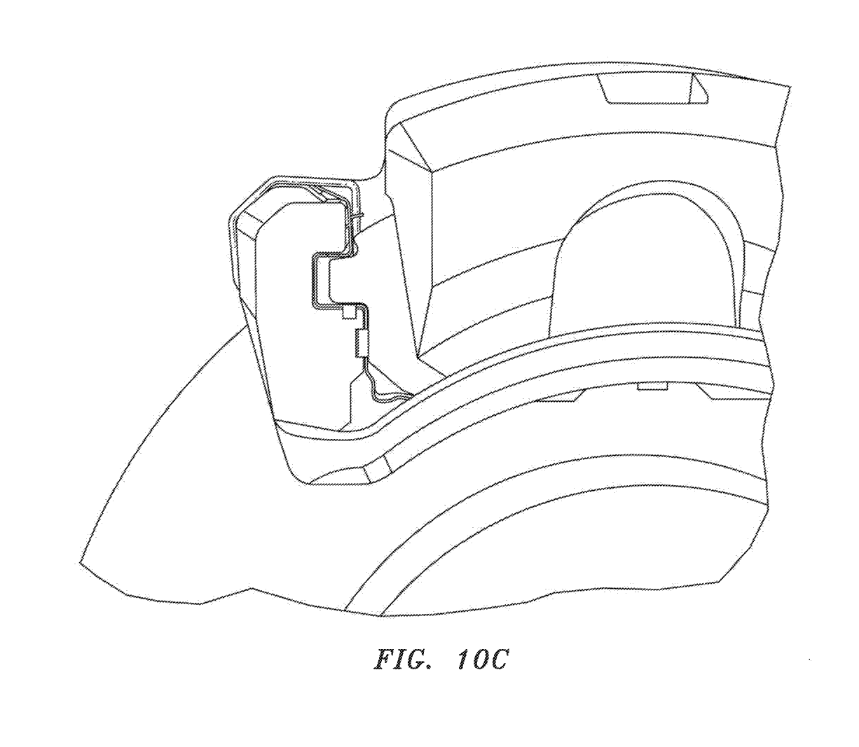

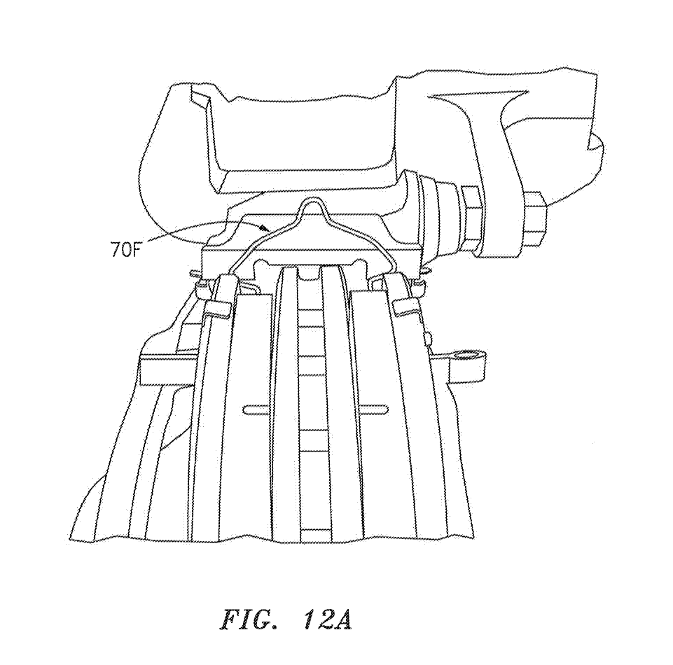

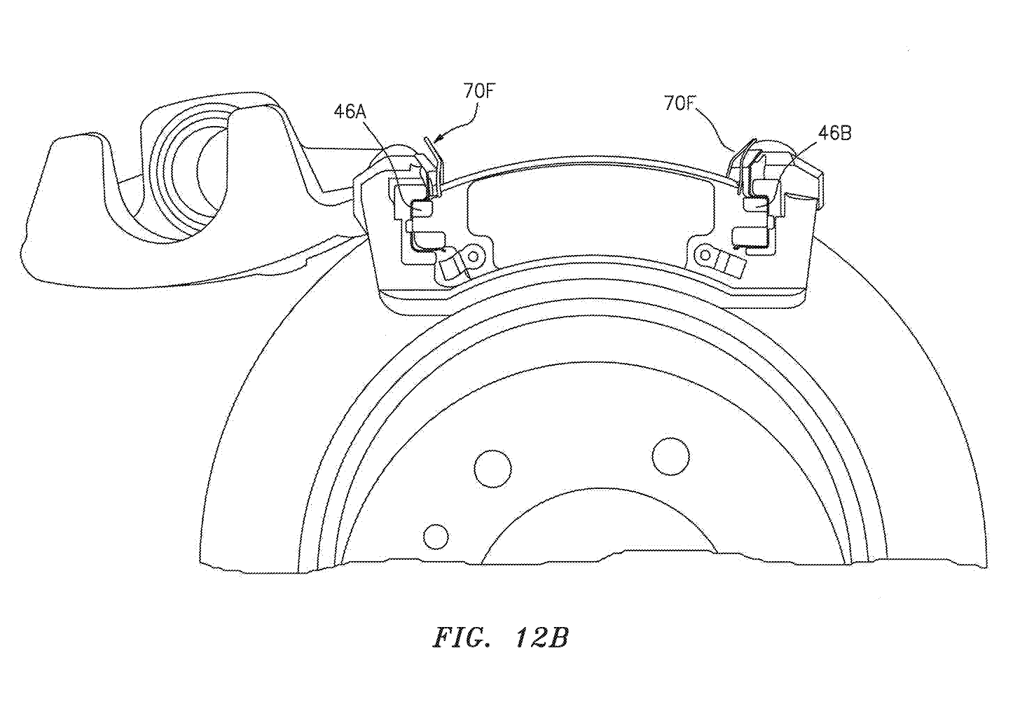

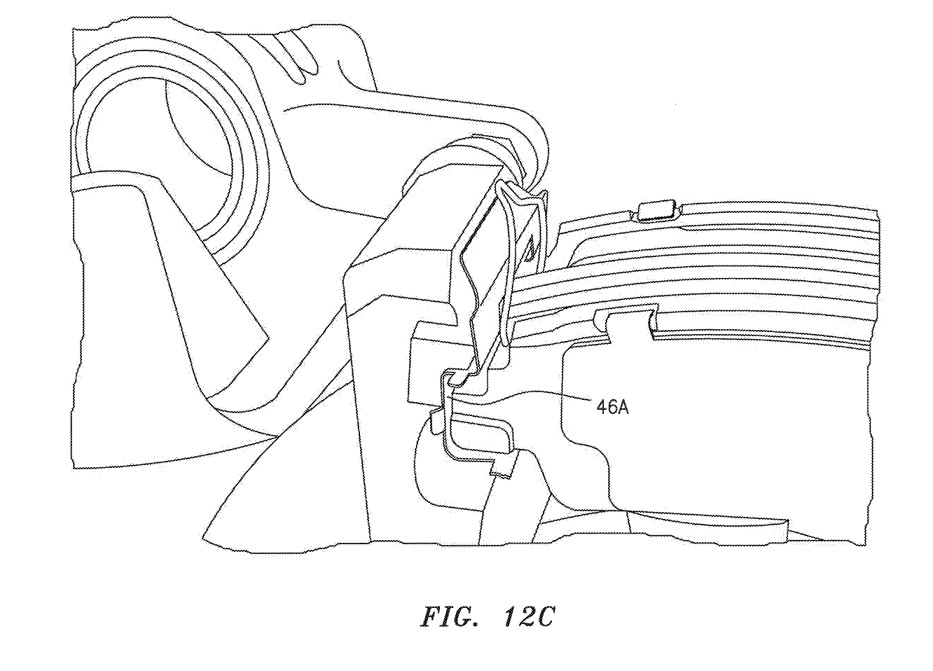

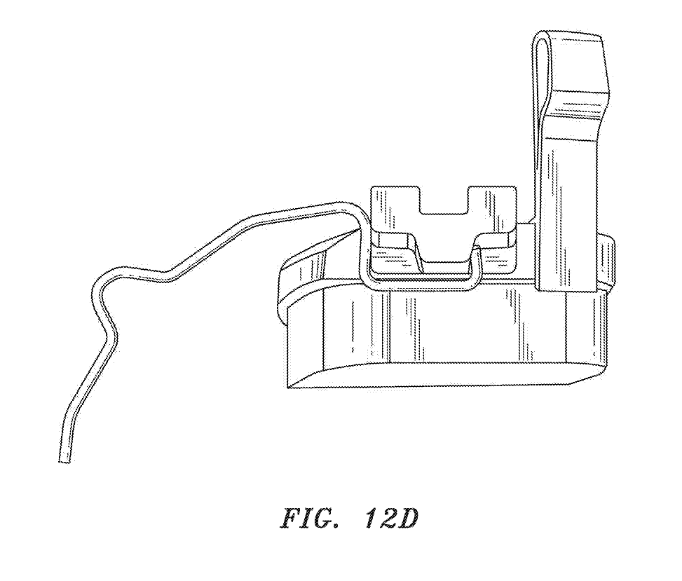

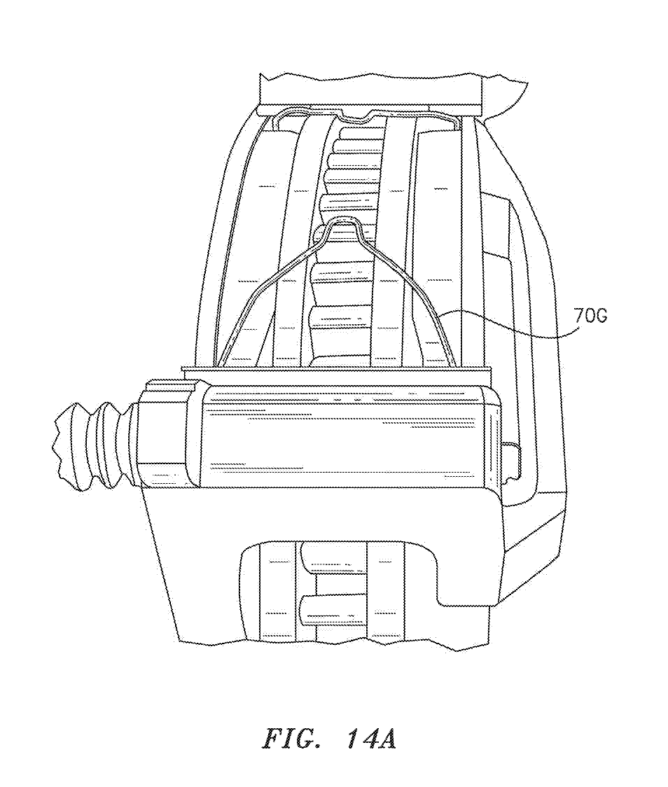

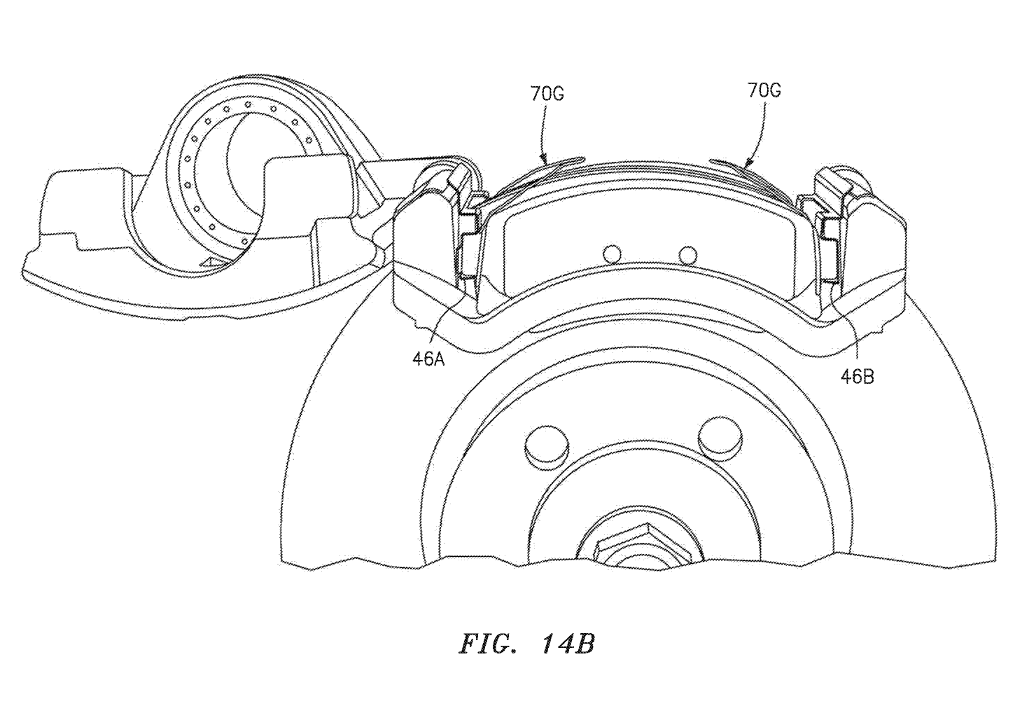

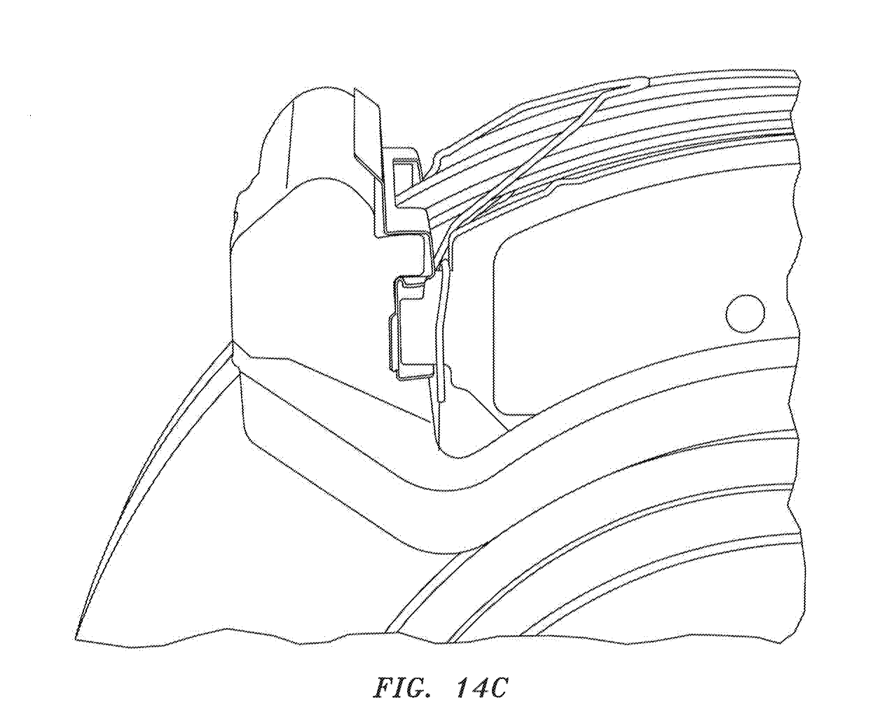

Reference is first made generally to FIGS. 2A, 2B, 2C; FIGS. 4A, 4B, 4C; FIGS. 6A, 6B, 6C, 6D, 6E; FIGS. 8A, 8B, 8C, 8D, 8E; FIGS. 10A, 10B, 10C; FIGS. 12A, 12B, 12C, 12D; and FIGS. 14A, 14B, 14C, all of which are generally views of conventional vehicle brake assemblies, such as disc-brake assemblies, in various states of assembly, generally showing the friction pad spreading devices constructed in accordance various preferred embodiments of the present invention.

For convenience, the various disc-brake assemblies will be generally indicated at 10, notwithstanding the various differences between them, all of which would be fully recognized by one skilled in the art. However, to appreciate the present invention, certain references to these figures will first be made. Generically, reference to “assembly 10” is intended to indicate that the present invention is equally applicable to all the disc brake assemblies disclosed herein.

By way of general background, it is well known to those skilled in the art that disc brake assemblies generally, and the embodiments disclosed herein, are used to stop a rotatable disc (i.e. rotor) 15, which rotates with the axle of a wheel to be braked. Assemblies 10 can be seen to include opposing braking subassemblies 17, 18, each of which preferably comprise a steel backing plate 20, a friction pad 25 mounted on the side of backing plate 20 facing rotor 15, and a shim 30 on the opposite side of backing plate 20. As will be discussed in greater detail below, the two backing plates 20 may be slidably mounted on guide rails (e.g. such as guide rails 46, 48, as illustrated in FIGS. 2, 4, 6 and 8 for example) or slidably mounted in slots (e.g. such as slots 46A, 48A, as illustrated in FIG. 10A, for example) in conventional caliper mounting structures, thus permitting backing plates 20 to axially slide toward and away from rotor 15. As would also be well understood, backing plates 20 are moved inwardly toward one another under the force applied by, for example, a caliper 40 and one or more hydraulically actuated piston 35. In such configurations, when piston(s) 35 and caliper 40 press backing plates 20 inwardly, the inner surfaces of friction pads 25 are engaged in frictional, braking contact with rotor 15.

Although the present invention is disclosed and illustrated in connection with the disc brake assemblies illustrated, it will be appreciated by those skilled in the art that the present invention is applicable with other brake assemblies, and such is contemplated by the disclosure and claims set forth herein.

In accordance with a preferred embodiment, assemblies 10 include a caliper bracket, generally indicated at 45, which is secured to a fixed, non-rotatable component of the vehicle (not shown).

As illustrated in the embodiments of FIGS. 2, 4, 6, 8 for example, caliper bracket 45 includes guide rails 46, 48 to which respective caliper abutment clips 47, 49, are preferably coupled. Guide rails 46, 48 extend in the direction “x” (perpendicular to the rotor), as illustrated for example, in FIG. 2B. Alternatively, as illustrated in the embodiments of FIGS. 10, 12, 14, caliper abutment clips are preferably configured for the respective slots 46A, 48A in caliper bracket 45. The slots also extend in a similar axial direction as the aforementioned guide rails, all as would be understood in the art.

As illustrated, each caliper bracket 45 slidably supports, on a first side thereof, the first end 17A of the first backing plate 17 and the first end 18A of the second backing plate 18, and, on a second side thereof, the second end 17B of the first backing plate 17 and the second end 18B of the second backing plate 18. In this way, the first end of the first backing plate is slidable along the first guide rail and the second end of the first backing plate is slidable along the second guide rail, and the first end of the second backing plate is slidable along the first guide rail and the second end of the second backing plate is slidable along the second guide rail. In an alternative embodiment, with the caliper bracket 45 including the aforementioned first slot and second slot, the first end of the first backing plate is slidable within the first slot and the second end of the first backing plate is slidable within the second slot, and the first end of the second backing plate is slidable within the first slot and the second end of the second backing plate is slidable within the second slot. In all such embodiments, the guide rails or slots provide for sliding movement of the subassemblies 17, 18.

To effect braking action of the wheel, caliper 40 and piston(s) 35 are provided for urging the braking subassemblies 17, 18, and friction pads 25 in particular, towards each other so as to frictionally engage the opposing sides of rotor 15. The particulars of a caliper and related assembly for the present invention is well known to those skilled in the art, and need not be elaborated on herein for purposes of brevity. To be sure however, the caliper and related assembly illustrated and disclosed in, for example, U.S. Pat. No. 5,549,181 can be used with the present invention and so the disclosure thereof is incorporated by reference herein in its entirety. That is, and as also would be understood by those skilled in the art, when it is desired to actuate the disc brake assembly 10 to stop the rotation of rotor 15 and the vehicle wheel associated therewith, the driver of the vehicle depresses the brake pedal (not shown), and as known in the art, the depression of the brake pedal causes pressurized hydraulic fluid to urge piston(s) 35 into engagement with braking subassembly 17. As a result and in the embodiments provided, friction pad 25 associated with braking subassembly 17 is moved into frictional engagement with the associated surface of rotor 15. At the same time, the caliper 40 slides in the opposite direction as would be understood in the art to urge friction pad 25 associated with braking subassembly 18 into frictional engagement with the associated outer surface of rotor 15. As a result, the rotor 15 is frictionally engaged by the friction pads 25 to inhibit relative rotational movement thereof.

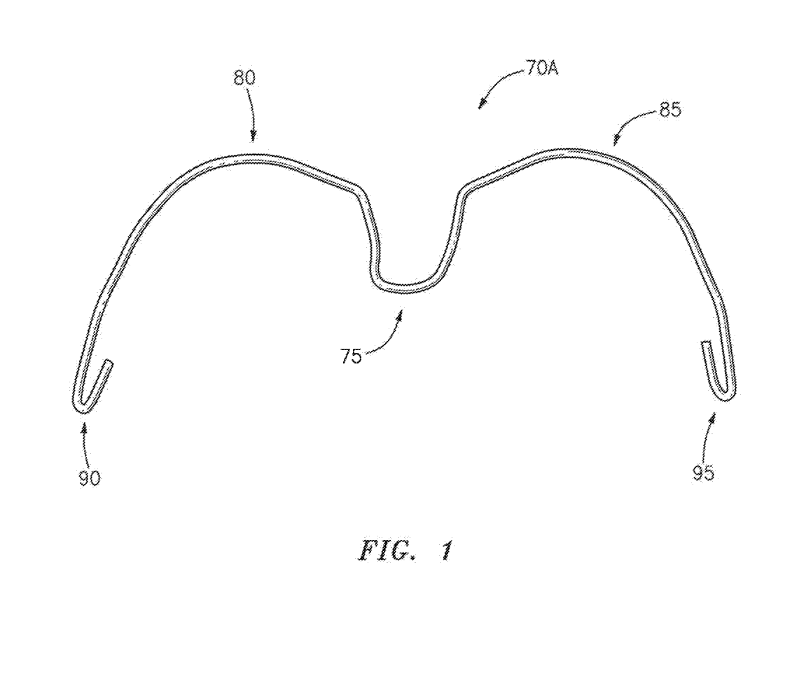

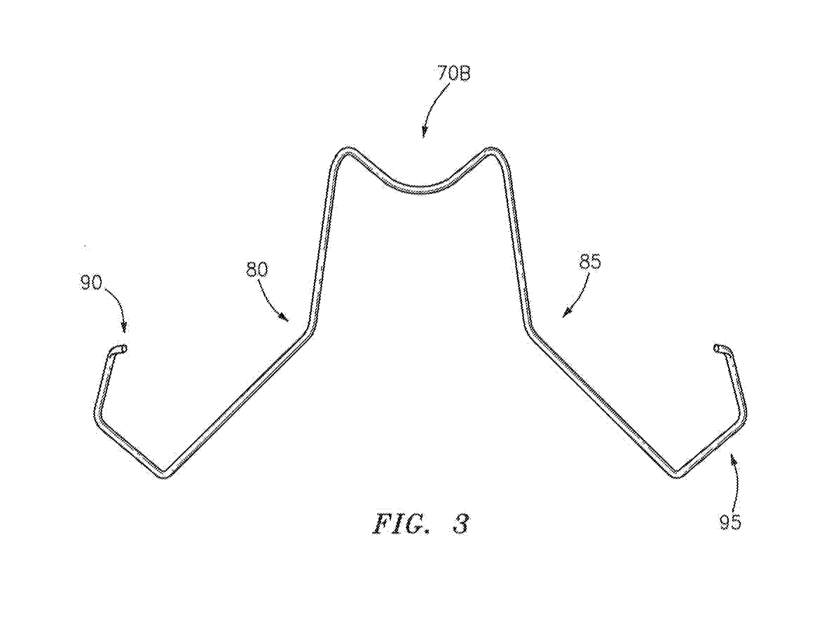

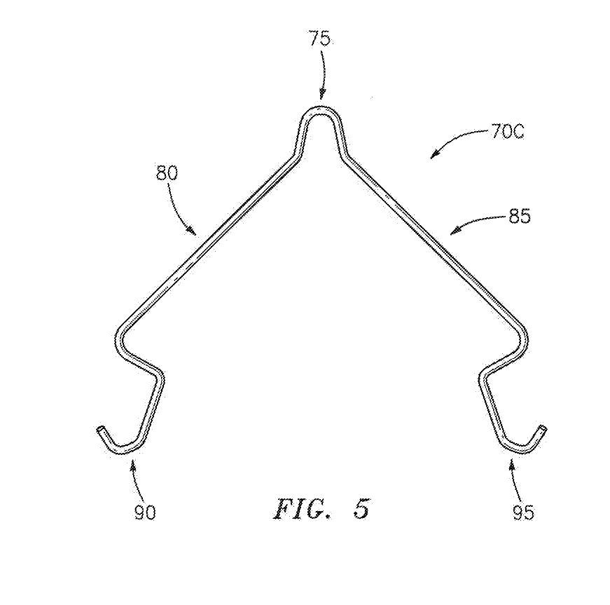

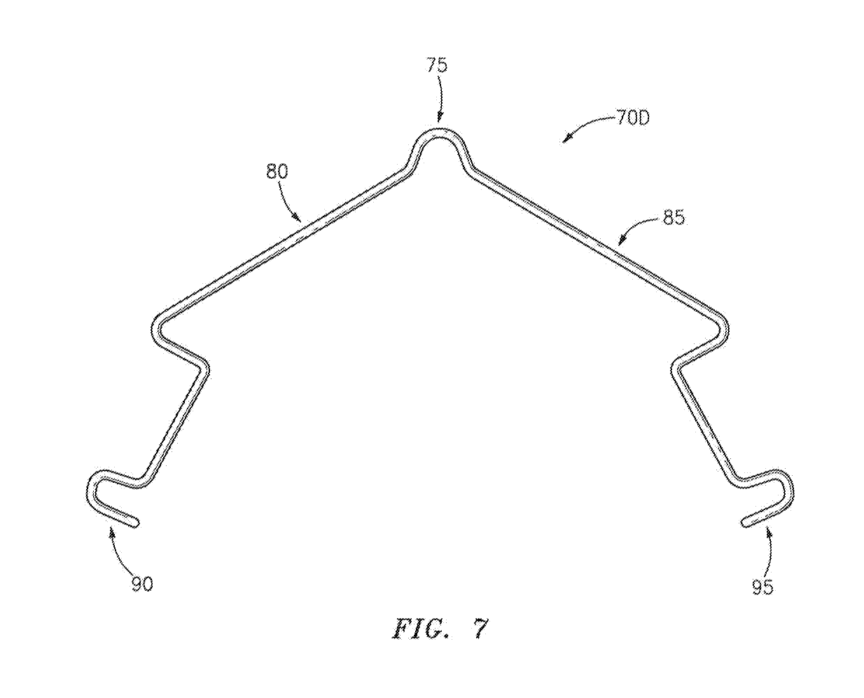

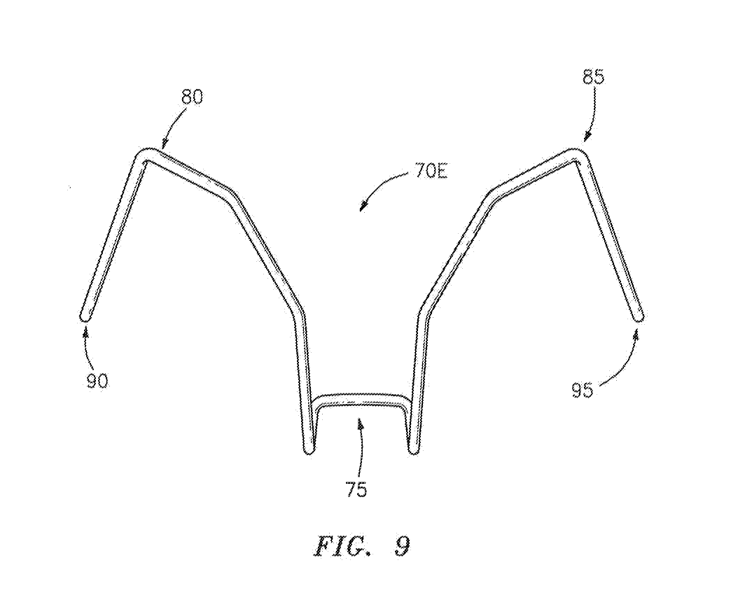

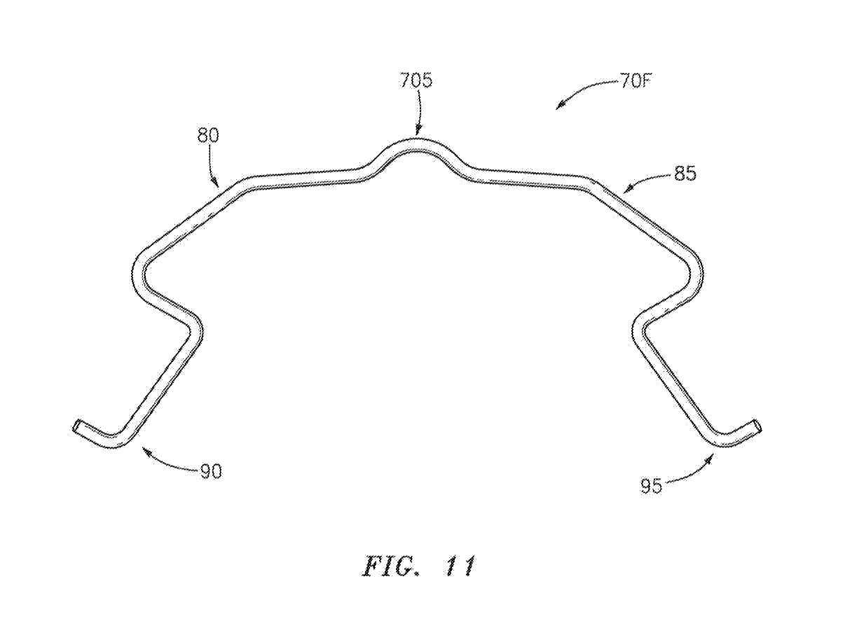

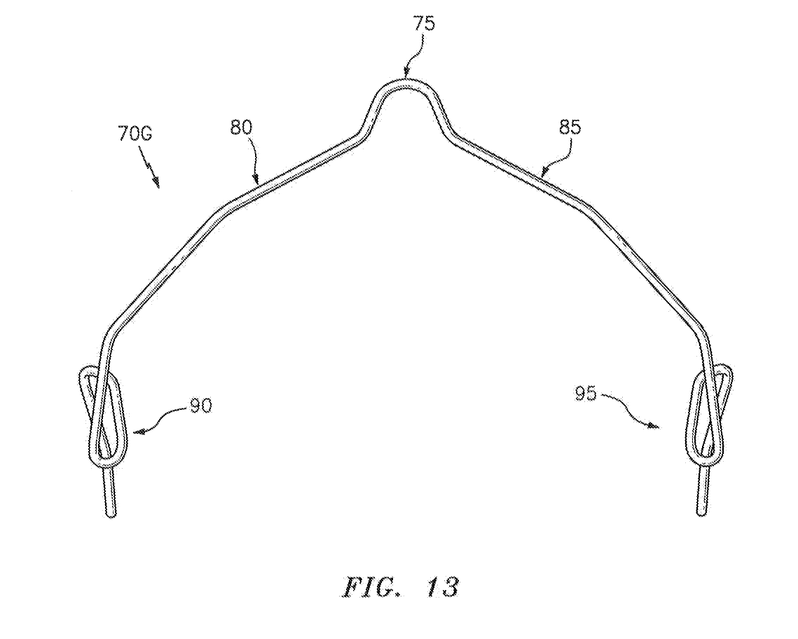

Now, in accordance with preferred embodiments of the present invention, pad spreaders, generally indicated at 70A in FIG. 1, 70B in FIG. 3, 70C in FIG. 5, 70D in FIG. FIG. 7, 70E in FIG. 9, 70F in FIGS. 11 and 70G in FIG. 13, are provided on opposing sides of caliper bracket 45 in each of the assemblies. A purpose of spreaders 70A, 70B, 70C, 70D, 70E and 70F (all of which may collectively be referred to as pad spreader “70”) are to apply a force to urge braking subassemblies 17, 18 away from rotor 15 when the brake pedal is released. To apply equal and corresponding forces, as mentioned above, preferably two (2) such spreaders 70 are used in each assembly 10, i.e. one on each side of assembly 10.

Preferably, the pad spreaders 70 used on each side of the caliper assembly are identical, and are preferably formed of stainless steel, music wire, harddrawn wire or galvanized harddrawn wire, although other materials can be used.

As illustrated in the various figures, the preferred pad spreaders 70 are formed of a central loop section, generally indicated at 75, and a pair of extending arms, each respectively indicated generally as 80, 85, which extend outwardly from loop section 75. As illustrated, in the preferred embodiments, arms 80, 85 are identical to each another. Some of the embodiments, such as pad spreaders 70A, 70C, 70D, 70F, 70G, may be seen to have respective “hands” generally indicated at 90, 95. Alternatively, such as in FIG. 70E, the arms do not form any particular shape at the distal ends thereof.

As illustrated in the embodiments of FIGS. 2 and 4, for example, “hand” sections 90, 95 extend over guide rails 46, 48 and clip thereon. If caliper abutment clips are used, then “hand” sections 90, 95 extend over such abutment clips and clip thereon, as illustrated in the figures. However, it will be appreciated that other shapes or curvatures may be provided in pad spreader 70, including those disclosed herein, while remaining within the scope of the invention.

Importantly, it should be noted that the profile and shape of arms 80, 85 for example, are generally provided to match and/or follow the outer curvature of the caliper bracket 45, and loop 75 is generally shaped to be able to clip onto the caliper bracket as illustrated in FIGS. 2 and 4, for example. In other embodiments, loop section 75 does not clip onto the caliper bracket but rather remains positioned above the braking subassemblies 17, 18 as shown in FIGS. 10, 12 and 14 for example. For this reason, the precise bend angle of loop section 75 is not as critical in these latter mentioned embodiments.

When installed as shown in the figures, each pad spreader 70 engages both the inner brake subassembly 17 and the outer brake assembly 18 to urge them apart from one another. For example, in the preferred embodiments, the ends of the arms of each spreader 70 (or “hands” as the case may be) preferably engage the ends 17A, 18A (e.g. the corners thereof) or 17B, 18B of the backing plates 20, as illustrated in the various figures. As illustrated, the first arm of the first pad spreader is in pressing engagement against the first end of the first backing plate and the second arm of the first pad spreader is in pressing engagement against the first end of the second backing plate, while the backing plates sits on the guide rails. Alternatively, in FIGS. 10, 12 and 14, the first arm of the second pad spreader is in pressing engagement against the second end of the first backing plate and the second arm of the second pad spreader is in pressing engagement against the second end of the second backing plate while the backing plates are positioned in the slots.

The other pad spreader 70, which is preferably identical, engages the opposite ends of the inner and outer brake subassemblies in a mirror image-like manner.

The pad spreader as illustrated in FIG. 13 differs from the others in that the hands actually are “wrapped” around the corners of the respective backing plates, as illustrated in FIG. 14, but in all other respects, functions similarly to the other pad spreaders disclosed herein.

In addition, in certain of the preferred embodiments, such as for example and not limitation with respect to pad spreaders 70A, 70B, each has a configuration and are used in connection with an assembly 10 such that they are further secured to the respective assembly 10 by the loop sections 75 being snap fit onto the caliper bracket 45. FIGS. 2 and 4 clearly illustrate this snap fitting arrangement of these pad spreader(s) being snap fitted on bracket 45. Alternatively, as also illustrated and discussed above, the pad spreaders of FIGS. 9, 11 and 13 are secured to its respective assembly by only the first and second arms of each pad spreader. That is, in these embodiments, the loop sections of both the first and second pad spreaders are not snap fit to the caliper bracket.

Preferably, the arms 80, 85 of each pad spreader 70 are slightly compressed between the inner and outer braking subassemblies 17, 18 when the disc brake assembly is not actuated, as illustrated. In this way, compression of the pad spreader 70 is maintained.

In operation, as braking subassemblies 17, 18 move inwardly toward each other, arms 80, 90 of the respective pad spreaders 70 compress. Because of the inherent resiliency of the material used to form the pad spreader 70 and the shape of loop section 75 and the arms themselves, each pad spreader 70 remains operative to exert a magnitude of force against each of the braking subassemblies 17, 18 urging them apart from one another. Each pad spreader 70 is designed to “spring back” and apply a restoring force sufficient to spread the braking subassemblies 17, 18 apart from one another when the disc brake assembly 10 is subsequently released.

Test results show that each pad spreader 70 exerts a sufficient amount of spring (i.e. biasing) force against the braking assemblies 17, 18 in order to reduce the active portion of the drag and reduce the amount of active gripping of the friction pads against the rotor.

Moreover, as known the art, as friction pads 25 wear down and become increasingly thinner with repeated usage of the disc brake assembly 10, such friction pads 25 must move closer toward one another when the brake pedal is depressed in order to frictionally engage rotor 15. However, pad spreaders 70 are effective in maintaining a sufficient magnitude of force against the backing plates 17, 18 to spread them apart after engagement with the rotor.

While the present invention has been illustrated and described in connection with a “sliding” caliper type of disc brake assembly, the invention may be used with other disc brake assemblies, as would be understood by those skilled in the art and therefore, the present invention should not be limited to only the disc brake assembly illustrated and discussed herein.

Reference is also briefly made to the figures in connection with the following for a discussion of referred mounting methods of the various embodiments of pad spreaders 70 onto various configurations of conventional braking assemblies. For example, and with reference to FIG. 2, in accordance with a preferred method, one may first loosen both caliper bolts 99. This will allow caliper 40 to pivot out of the way once one of the bolts is removed. Then, remove one of the caliper bolts and pivot the caliper to one side as shown. If the brake lines prevent the caliper from fully opening, replace the bolt and remove the other one. As the caliper is opened, it is preferable to clamp the friction pads 25 firmly against the rotor as shown. In a preferred embodiment, a “C-clamp” may be used to maintain the brake subassemblies 17, 18 firmly against rotor 15, as illustrated. The clamp is used to prevent the pads from being forced apart by the springs prior to replacing the caliper over the pads. Pad spreader 70A is then snapped into place under the brake pad tabs as shown in FIGS. 2B, 2C. Loop section 75 is then also snapped into place on the bottom side of caliper bracket 45 as illustrated in FIG. 2B. A second pad spreader 70A is mounted on the opposite side of caliper bracket 45 in the same foregoing manner, thereby providing two pad spreaders as illustrated in FIGS. 2A, 2B. Caliper 40 is then replaced while carefully removing the clamp as the caliper is closed over the pads. Caliper bolts 99 are then inserted and tightened, which then completes one preferred method of installing pad spreaders 70.

Reference is now made to FIG. 4, in accordance with another preferred method of assembly, in which is shown that one of the caliper bolts 99 is again removed and the caliper 40 is opened while carefully similarly clamping the two brake pads firmly against the rotor using, for example, a “C-clamp” as illustrated. In this embodiment, the two (2) pad spreaders 70B are inserted between the brake pads and over the pad clips as illustrated, which is similar to the coupling of the pad spreaders to the guide rails (i.e. and over the abutment clips when provided) in the embodiments of FIGS. 2 and 4, for example and not limitation. Here again, the loop sections must snap into place under the caliper bracket as shown in FIG. 4C. The caliper can then be replaced while carefully removing the clamp as the caliper is closed over the pads. The caliper bolts 99 are likewise then reinserted and tightened, thus completing another preferred method of installing pad spreaders 70.

Reference is now made to FIG. 6, in accordance with yet another preferred method of assembly, in which it is desirable again to first remove both caliper bolts. Then, facing the caliper, lift the left side of the body until the body tab (see FIG. 6E) unsnaps from the clip spring (see FIG. 6D). This will allow the caliper body to be completely removed, as illustrated in FIG. 6A. Next, but before attaching pad spreaders 70C, first clamp the brake pads firmly against the rotor similar to that disclosed above. Once friction pads 25 are secure, insert the ends (i.e. “hands”) of the pad spreaders around the respective ends (17A, 17B) of backing plate 17 and around the ends (18A, 18B) of backing plate 18, as well as under the pad clip, as illustrated. The ends of the pad spreaders 70C (i.e. the “hands”) should snap into place under the brake pad clip, and now, with the pad spreaders 70C installed, the loop section 75 will face away from the rotor surface. With both springs installed, remove the clamp while manually holding the pads together to prevent them from moving apart from the spring tension. Next, latch the right side of the caliper body to the bracket and close so that the body tab snaps into place under the clip spring, thus completing yet another preferred method of installing pad spreaders 70.

Reference is now made to FIG. 8, in accordance with yet a further preferred method of assembly, in which it is shown to remove both caliper bolts, lift the left side of the body until the body tab unsnaps from the clip spring (see FIG. 8B). This will allow the caliper body to be completely removed, as illustrated. Before attaching the spreader springs, clamp the brake pads firmly against the rotor, as illustrated. Once the pads are secure, insert the end loops (i.e. “hands”) of the pad spreaders around the respective ends (17A, 17B) of backing plate 17 and around the ends (18A, 18B) of backing plate 18, as well as under the pad clip, as illustrated. The spring loops must snap into place under the brake pad clip. With the pad spreaders installed, the loop sections face away from the rotor surface. With both pad spreaders installed, remove the clamp while manually holding the pads together to prevent them from moving apart from the spring tension. Latch the right side of the caliper body to the bracket and close so that the body tab snaps into place under the clip spring, thus completing yet another preferred method of installing pad spreaders 70.

Reference is now made to FIG. 10, in accordance with yet a further preferred method of assembly, in which it is shown that first it is desirable to loosen both caliper bolts, which again, will allow the caliper to pivot out of the way once one of the bolts are removed. Remove one of the caliper bolts and pivot the caliper as shown. If the brake lines prevent the caliper from fully opening, replace the bolt and remove the other one, and pivot the caliper in the opposite direction. As the caliper is opened, clamp the pads firmly against the rotor as illustrated. One of the pad spreaders may be installed before the clamp is secured. Here again, the clamp is preferably used to prevent the pads from being forced apart by the pad spreaders prior to replacing the caliper over the pads. The pad spreaders need to snap into place behind the brake pad tabs and backing plates as shown. Replace the caliper while carefully removing the clamp as the caliper is repositioned over the pads. Insert and tighten the caliper bolts, thus completing yet another preferred method of installing pad spreaders 70.

Reference is now made to FIG. 12, in accordance with yet a further preferred method of assembly, in which it is shown to first loosen both caliper bolts, which again, allows the caliper to pivot out of the way once one of the bolts is removed. Next, remove one of the caliper bolts and pivot the caliper to one side as shown. Again, if the brake lines prevent the caliper from fully opening, replace the bolt and remove the other one. As you open the caliper, clamp the pads firmly against the rotor as shown. Again, one of the pad spreaders 70F of this embodiment may be installed before the clamp is secured. The pad spreaders must snap into place behind the brake pad tabs as shown. Replace the caliper while carefully removing the damp as the caliper is closed over the pads. Insert and tighten the caliper bolts to complete yet another preferred method of installing pad spreaders 70.

Reference is lastly made to FIG. 14, in accordance with yet a further preferred method of assembly, in which it is shown to again, loosen both caliper bolts to allow the caliper to pivot out of the way once one of the bolts are removed. Next, remove one of the caliper bolts and pivot the caliper as shown, and again, if the brake lines prevent the caliper from fully opening, replace the bolt and remove the other one, and pivot the caliper in the opposite direction. As the caliper is opened, clamp the pads firmly against the rotor as shown. Again, one of the pad spreaders may be installed before the clamp is secured. The pad spreader 70G must snap into place under the brake pad tabs as shown with the loop section facing inward as shown. Lastly, replace the caliper while carefully removing the clamp as the caliper is repositioned over the pads. Insert and tighten the caliper bolts to complete this preferred method of assembly.

While the invention has been particularly shown and described with respect to preferred embodiments thereof, it will be understood by those skilled in the art that changes in form and details may be made therein without departing from the scope and spirit of the invention.

It can thus be see that an improved friction pad spreading device that overcomes the perceived deficiencies in the prior art is provided. In particular, the improved friction pad spreading device as set forth herein effectively operates over the life of the friction pads, thereby providing sufficient compression and restoring forces regardless of the wear upon the friction pad. Based thereon, it can also be see that the present invention provides for increased gas mileage and prolonged life of the braking pad because of the reduction in drag and friction of the friction pads against the rotor, just to name but a few advantageous results.

What is claimed is:

1. A friction pad drag reduction assembly for reducing drag between a rotor and at least a first friction pad of a first braking subassembly that itself also comprises a first backing plate, wherein the first backing plate comprises a first end and a second end, wherein the assembly comprises:
a second braking subassembly comprising a second friction pad in facing alignment with the rotor, and a second backing plate to which the second friction pad is coupled, the second backing plate having a first end and a second end;
a caliper bracket that slidably supports, on a first side thereof, the first end of the first backing plate and the first end of the second backing plate, and, on a second side thereof, the second end of the first backing plate and the second end of the second backing plate;
a first pad spreader, comprising a loop section and at least a first end and a second end, wherein the first end engages the first end of the first backing plate and the second end engages the first end of the second backing plate;
a second pad spreader, comprising a loop section and at least a first end and a second end, wherein the first end engages the second end of the first backing plate and the second end engages the second end of the second backing plate;
wherein the first and second spreaders are secured to the assembly by (i) only the first and second ends of each pad spreader or (ii) the first and second ends of each pad spreader along with the respective loop sections of both the first pad spreader and the second pad spreader being snap fit onto the caliper bracket;
wherein upon an application of a braking force, the assembly urges the first friction pad of the first braking subassembly and the second friction pad of the second braking subassembly towards the rotor; and
upon a removal of the braking force, the first and second pad spreaders urge the first friction pad of the first braking subassembly and the second friction pad of the second braking subassembly away from the rotor.

2. The friction pad drag reduction assembly as claimed in claim 1, wherein:
the caliper bracket includes a first guide rail and a second guide rail, wherein the first end of the first backing plate is slidable along the first guide rail and the second end of the first backing plate is slidable along the second guide rail, and the first end of the second backing plate is slidable along the first guide rail and the second end of the second backing plate is slidable along the second guide rail,
the first end of the first pad spreader is in pressing engagement against the first end of the first backing plate and the second end of the first pad spreader is in pressing engagement against the first end of the second backing plate;
the first end of the second pad spreader is in pressing engagement against the second end of the first backing plate and the second end of the second pad spreader is in pressing engagement against the second end of the second backing plate; and
the loop sections of both the first and second pad spreaders are snap fit onto the caliper bracket.

3. The friction pad drag reduction assembly as claimed in claim 1, wherein:
the caliper bracket includes a first guide rail and a second guide rail, wherein the first end of the first backing plate is slidable along the first guide rail and the second end of the first backing plate is slidable along the second guide rail, and the first end of the second backing plate is slidable along the first guide rail and the second end of the second backing plate is slidable along the second guide rail,
the first end of the first pad spreader is in pressing engagement against the first end of the first backing plate and the second end of the first pad spreader is in pressing engagement against the first end of the second backing plate;
the first end of the second pad spreader is in pressing engagement against the second end of the first backing plate and the second end of the second pad spreader is in pressing engagement against the second end of the second backing plate; and
the loop sections of both the first and second pad spreaders are not snap fit to the caliper bracket.

4. The friction pad drag reduction assembly as claimed in claim 1, wherein:
the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot,
the first end of the first pad spreader is in pressing engagement against the first end of the first backing plate and the second end of the first pad spreader is in pressing engagement against the first end of the second backing plate;
the first end of the second pad spreader is in pressing engagement against the second end of the first backing plate and the second end of the second pad spreader is in pressing engagement against the second end of the second backing plate; and
the loop sections of both the first and second pad spreaders are snap fit onto the caliper bracket.

5. The friction pad drag reduction assembly as claimed in claim 1, wherein:
the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot,
the first end of the first pad spreader is in pressing engagement against the first end of the first backing plate and the second end of the first pad spreader is in pressing engagement against the first end of the second backing plate;
the first end of the second pad spreader is in pressing engagement against the second end of the first backing plate and the second end of the second pad spreader is in pressing engagement against the second end of the second backing plate; and
the loop sections of both the first and second pad spreaders are not snap fit to the caliper bracket.

6. The friction pad drag reduction assembly as claimed in claim 1, wherein:
the caliper bracket includes a first slot and a second slot, wherein the first end of the first backing plate is slidable within the first slot and the second end of the first backing plate is slidable within the second slot, and the first end of the second backing plate is slidable within the first slot and the second end of the second backing plate is slidable within the second slot,
the first end of the first pad spreader wraps around the first end of the first backing plate and the second end of the first pad spreader wraps around the first end of the second backing plate;
the first end of the second pad spreader wraps around the second end of the first backing plate and the second end of the second pad spreader wraps around the second end of the second backing plate; and
the loop sections of both the first and second pad spreaders are not snap fit to the caliper bracket.

7. A pad spreader for use in a drag reduction assembly for reducing drag between a rotor and at least a first friction pad of a first braking subassembly that itself also comprises a first backing plate, wherein the first backing plate comprises a first end and a second end, wherein the assembly comprises a second braking subassembly comprising a second friction pad in facing alignment with the rotor, and a second backing plate to which the second friction pad is coupled, the second backing plate having a first end and a second end; a caliper bracket that slidably supports, on a first side thereof, the first end of the first backing plate and the first end of the second backing plate, and, on a second side thereof, the second end of the first backing plate and the second end of the second backing plate; wherein the pad spreader comprises:
a loop section and at least a first end and a second end, wherein when assembled into a drag reduction assembly, the first end engages the first end of the first backing plate and the second end engages the first end of the second backing plate; and
wherein pad spreader is secured to the assembly by (i) only the first and second end of the pad spreader or (ii) the first and second end of the pad spreader along with the loop section being snap fit onto the caliper bracket;
wherein upon an application of a braking force, the assembly urges the first friction pad of the first braking subassembly and the second friction pad of the second braking subassembly towards the rotor; and
upon a removal of the braking force, the pad spreader urge the first friction pad of the first braking subassembly and the second friction pad of the second braking subassembly away from the rotor.

8. A method of assembling a friction pad drag reduction assembly for reducing drag between a rotor and at least a first friction pad of a first braking subassembly that itself also comprises a first backing plate, wherein the first backing plate comprises a first end and a second end, wherein the assembly comprises a second braking subassembly comprising a second friction pad in facing alignment with the rotor, and a second backing plate to which the second friction pad is coupled, the second backing plate having a first end and a second end; a caliper bracket that slidably supports, on a first side thereof, the first end of the first backing plate and the first end of the second backing plate, and, on a second side thereof, the second end of the first backing plate and the second end of the second backing plate; a first pad spreader, comprising a loop section and at least a first end and a second end, wherein the first end engages the first end of the first backing plate and the second end engages the first end of the second backing plate; and a second pad spreader, comprising a loop section and at least a first end and a second end, wherein the first end engages the second end of the first backing plate and the second end engages the second end of the second backing plate; wherein the first and second spreaders are secured to the assembly by (i) only the first and second ends of each pad spreader or (ii) the first and second ends of each pad spreader along with the respective loop sections of both the first pad spreader and the second pad spreader being snap fit onto the caliper bracket; wherein upon an application of a braking force, the assembly urges the first friction pad of the first braking subassembly and the second friction pad of the second braking subassembly towards the rotor; and upon a removal of the braking force, the first and second pad spreaders urge the first friction pad of the first braking subassembly and the second friction pad of the second braking subassembly away from the rotor; wherein the method comprises the steps of
removing a bracket bolt so as to permit rotation of a caliper about an axis of rotation;
compressing the first and second braking assemblies against the rotor;
engaging at least one of (i) the first end of the first pad spreader with the first end of the first backing plate and engaging the second end of the first pad spreader with the first end of the second backing plate and (ii) engaging the first end of the second pad spreader with the second end of the first backing plate and engaging the second end of the second pad spreader with the second end of the second backing plate;
removing the compression of the first and second braking assemblies and rotating the caliper back over the braking subassemblies; and
replacing the bracket bolt.

9. The method as claimed in claim 8, including the step snap fitting the loop sections of both the first pad spreader and the second pad spreader onto the caliper bracket.

10. The method as claimed in claim 8, including engaging the first pad spreader with the first backing plate and the second backing plate prior to the step of compressing the first and second braking assemblies against the rotor; and engaging the second pad spreader with the first backing plate and the second backing plate after the step compressing the first and second braking assemblies against the rotor.

11. The method as claimed in claim 8, including engaging the first pad spreader with the first backing plate and the second backing plate and engaging the second pad spreader with the first backing plate and the second backing plate prior to the step of compressing the first and second braking assemblies against the rotor.

12. The method as claimed in claim 8, wherein the caliper bracket includes a first guide rail and a second guide rail, wherein the first end of the first backing plate is slidable along the first guide rail and the second end of the first backing plate is slidable along the second guide rail, and the first end of the second backing plate is slidable along the first guide rail and the second end of the second backing plate is slidable along the second guide rail, wherein the method comprises the step of coupling the ends of the first pad spreader over the first guide rail.

13. The method as claimed in claim 12, including the step of coupling the ends of the second pad spreader over the second guide rail.
